(19) United States
(12) Patent Application Publication
(10) Pub. No.: US 2012/0185546 A1
(43) Pub. Date: Jul. 19, 2012

(54) METHOD AND APPARATUS FOR AUTOMATICALLY CONFIGURING EMAIL COMMUNICATION

(75) Inventor: Rajan DAHIYA, Bangalore (IN)

(73) Assignee: Samsung Electronics Co., Ltd., Suwonn-si (KR)

(21) Appl. No.: 13/351,672

(22) Filed: Jan. 17, 2012

(30) Foreign Application Priority Data
Jan. 17, 2011 (IN) 158/CHE/2011
Dec. 19, 2011 (KR) 10-2011-0137090

(51) Int. Cl. G06F 15/16

(52) U.S. Cl. 709/206

(57) ABSTRACT

A method and apparatus are provided for automatically configuring an email communication based on attachment files. When a plurality of files are selected for attachment to an email message, at least one parameter associated with the plurality of files is selected. When the at least one parameter is greater than a threshold, a plurality of email messages are generated that include the plurality of files based on an optimal set of files from the plurality of files. The optimal set is determined according to individual sizes of each of the plurality of files. The plurality of email messages are sent.

### PRIORITY

This application claims priority under 35 U.S.C. §119(a) to an Indian Patent Application filed in the Indian Patent Office on Jan. 17, 2011 and assigned Serial No. 158/CHE/2011, and a Korean Patent Application filed in the Korean Intellectual Property Office on Dec. 19, 2011 and assigned Serial No. 10-2011-0137090, the entire disclosures of which are incorporated herein by reference.

### BACKGROUND OF THE INVENTION

1. Field of the Invention

The present invention relates generally to data communication, and more particularly, to a method and device for automatically configuring an email communication based on attachment files.

2. Description of the Related Art

Several email clients and their various functionalities are widely known. Email clients can be classified in two categories in terms of attachments. A first classification of email clients does not impose any restriction on file attachments. These email clients can be configured to use emailing servers for the sending or receiving of emails through established protocols. An unlimited number of files of various sizes can be sent using these email clients. A second classification of email clients include customized clients, such as, for example, the email clients featured in mobile phones, which impose a restriction on a maximum size of an attachment that can be sent with a message. This restriction can be due to a message handling capacity of the email client or it can be a network imposed restriction.

Generally, servers/accounts that are used for email messaging purposes have two common restrictions, which include, for example, a maximum size for an attachment per email message, and a number of files attached per email message. Email clients of the first category, which do not impose any restriction in terms of size or number of attachments, face a problem when the outgoing mail server terminates the sending of an email message citing “message size exceeded” as the reason for termination. The user may unknowingly attach several files in a message that has been composed using an email client of the first category. Therefore, after waiting for several minutes, the user must reconfigure the email message once the recognizes that the message delivery has failed.

The email clients belonging to the second category may forbid the user to send an email message before beginning the transmission. Thus, the user is forced to reconsider and configure his attachments appropriately. When a message is configured using an email client belonging to the second category, the user is not made to wait for an indication of message delivery failure. However, the burden of composing several email messages still falls upon the user, if he/she intends to send several attachments, having a size greater than the permissible size.

### SUMMARY OF THE INVENTION

The present invention has been made to address at least the above problems and/or disadvantages and to provide at least the advantages described below. Accordingly, an aspect of the present invention provides a method and device for automatically configuring an email communication based on attachment files.

According to an aspect of the present invention, a method is provided for automatically configuring an email communication based on attachment files. When a plurality of files are selected for attachment to an email message, at least one parameter associated with the plurality of files is selected. When the at least one parameter is greater than a threshold, a plurality of email messages are generated that include the plurality of files based on an optimal set of files from the plurality of files. The optimal set is determined according to individual sizes of each of the plurality of files. The plurality of email messages are sent.

According to another aspect of the present invention, an apparatus is provided for automatically configuring an email communication. The apparatus includes an email client for determining at least one parameter associated with a plurality of files to be included in an email message, and, when the at least one parameter is greater than a threshold, generating a plurality of email messages including the plurality of files based on an optimal set of files from the plurality of files, and sending the plurality of email messages. The optimal set is determined according to individual sizes of each of the plurality of files.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a flowchart illustrating the processing of an email communication based on attachment files, according to an embodiment of the present invention;

FIG. 2 is a flowchart illustrating the forming of a superset of attachment files, according to an embodiment of the present invention;

FIG. 3 is a flowchart illustrating the forming of one or a plurality of optimal sets from the superset of attachment files, according to an embodiment of the present invention;

FIG. 4 is a schematic representation illustrating construction of a superset and forming optimal sets using the superset, according to an embodiment of the present invention; and

FIG. 5 is a structural diagram of a computing device, according to an embodiment of the present invention.

### DETAILED DESCRIPTION OF EMBODIMENTS OF THE PRESENT INVENTION

The present invention provides a method and apparatus for automatically configuring an email communication based on attachment files. In the following detailed description of embodiments of the present invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The same or similar components may be designed by the same or similar reference numerals although they are illustrated in different drawings. Detailed descriptions of constructions or processes known in the art may be omitted to avoid obscuring the subject matter of the present invention.

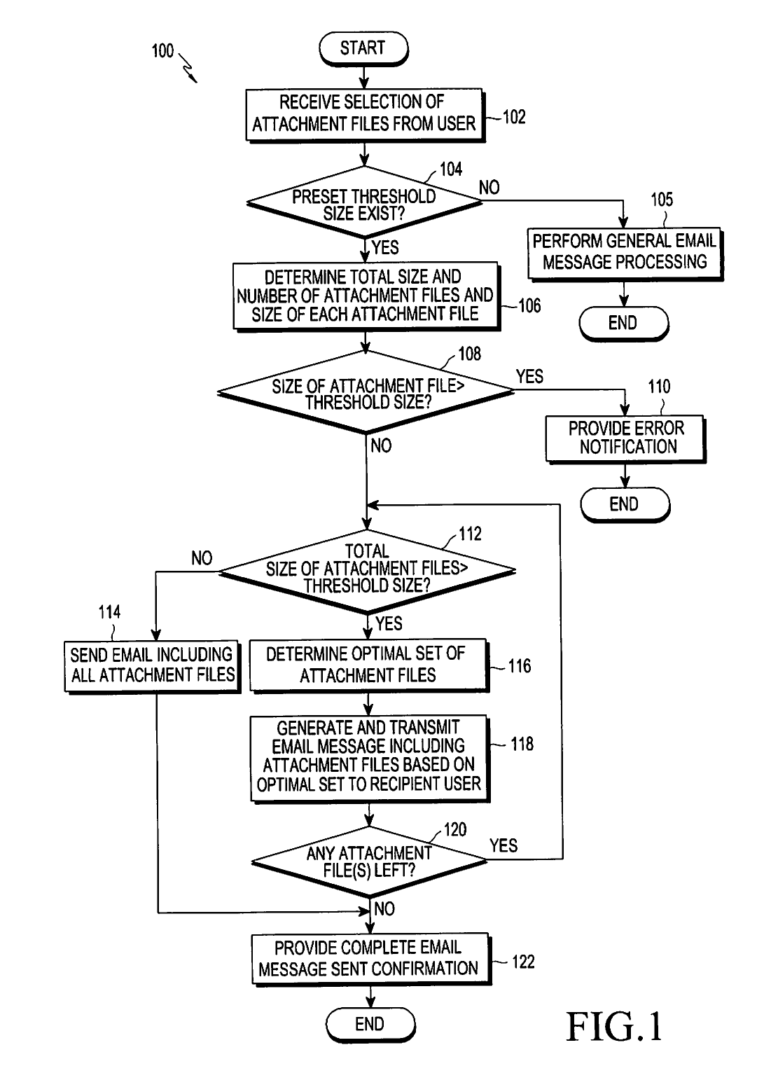

FIG. 1 is a flowchart 100 illustrating the processing of an email communication based on attachment files, according to an embodiment of the present invention. In an embodiment of the present invention, a user is composing an email communication through an email client and wishes to send a plurality of attachment files to a recipient. Once a selection of attachment files associated with the email communication is received from the user in step 102, it is determined whether a preset threshold size exists in step 104. The preset threshold size is a maximum permissible size of attachment files that can be sent with the email communication. The preset threshold size may be set by an email server or an email client. If it is determined that the preset threshold size exists, various parameters associated with the attachment files are determined in step 106. The various parameters may include, for example, a total size of the attachment files, a number of attachment files selected by the user, and a size of each of the attachment files. If it is determined that the preset threshold size does not exist, general email processing is performed in step 105, before terminating the methodology.

In step 108, it is determined whether the size of each of the attachment files is greater than the preset threshold size. If it is determined that an attachment file, from among the plurality of attachment files, has a size greater than the preset threshold size, an error notification is provided that indicates that the attachment file is of a large size, in step 110, before terminating the methodology. If the size of the attachment file is less than or equal to the preset threshold size, the total size of the attachment files is compared with the preset threshold size in step 112. If the total size of the attachment files is less than or equal to the preset threshold size, an email message including all of the attachment files is sent in step 114, and a confirmation indicating that the complete email message was sent is provided in step 122.

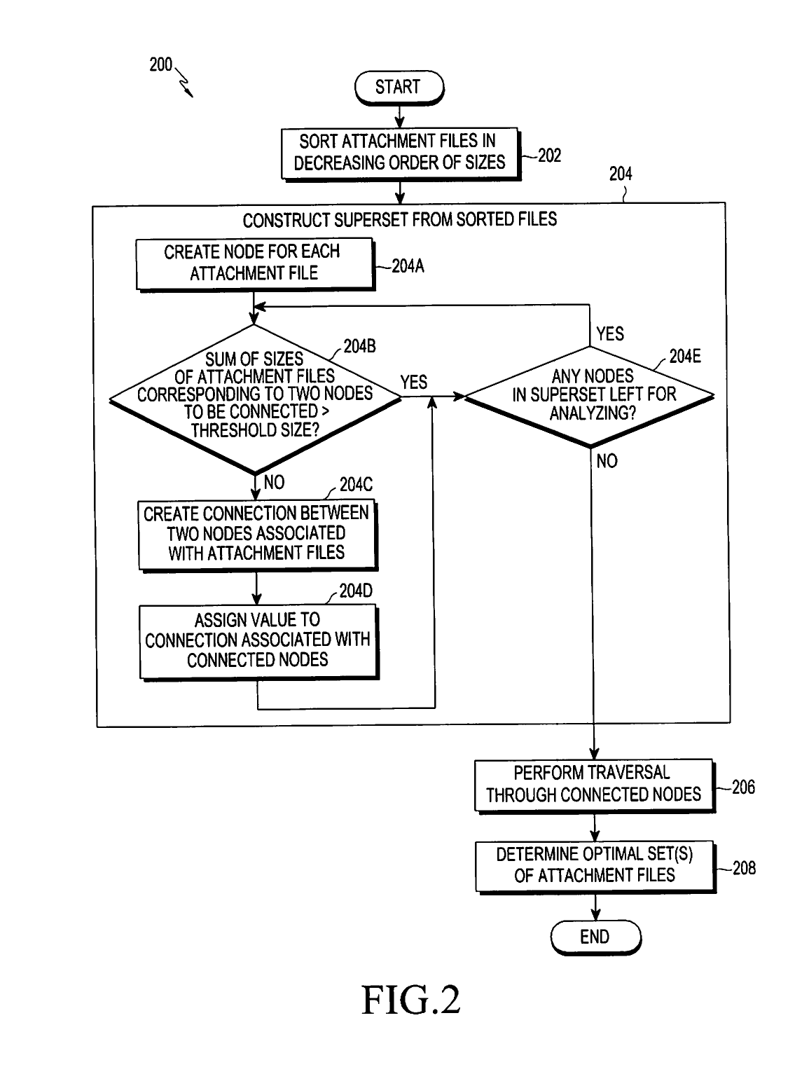

If the total size of the attachment files is greater than the preset threshold size, an optimal set of attachment files is determined, in step 116, in order to maximize the number of attachments in a single email message. The determination of the optimal set of attachment files, in step 116, is described in greater detail below, with reference to FIG. 2. In step 118, an email message including one or more of the attachment files is generated based on the optimal set of attachment files, and the generated email message is sent to the recipient.

In step 120, it is determined whether any other attachment files are left that are to be included in one or more email messages. If other attachment files are left, the methodology returns to step 112. If no other attachment files are left, the user is notified that a complete email communication along with the attachment files is sent to the recipient, in step 122. A subject field in the one or more email messages carrying the attachment files in the optimal sets is appended to indicate ‘part 1’, ‘part 2’, and so on, such that the recipient knows that the one or more email messages are part of the same email communication, but include different attachment files.

FIG. 2 is a flowchart illustrating the forming of a superset of attachment files, according to an embodiment of the present invention.

In step 202, the attachment files selected by the user are sorted in decreasing size order. In step 204, a superset of attachment files is created based on the sorted attachment files. Steps 204A through 204E illustrate, in detail, the construction of a superset of the attachment files.

In step 204A, a node is created for each of the sorted attachment files. For example, a first node in the superset is created for an attachment file with a largest size that is at the top of the list of sorted attachment files. A last node in the superset is created for an attachment file with a smallest size that is at the bottom of the list of sorted attachment files.

In step 204B, it is determined whether a sum of sizes of the attachment files corresponding to any two nodes to be connected is greater than the preset threshold size. If the sum of sizes of the attachment files is less than or equal to the threshold size, the two nodes are connected using a valid interconnection, in step 204C.

In step 204D, a value equal to a sum of the sizes of the attachment files, corresponding to the connected nodes, is assigned to the interconnection between the two connected nodes. The methodology continues to step 204E, where it is determined whether any nodes are left in the superset to be analyzed for making a connection. Also, if it is determined that the sum of sizes of the attachment files is greater than the preset threshold size, in step 204B, the methodology also proceeds to step 204E. If nodes are left to be analyzed, the methodology returns to step 204B, and step 204 is repeated until all of the nodes are analyzed. If there are no nodes left in the superset to be analyzed for making a connection, the methodology proceeds to step 206. Through the foregoing steps, the superset with nodes equal to the number of attachment files and interconnections between the nodes is constructed.

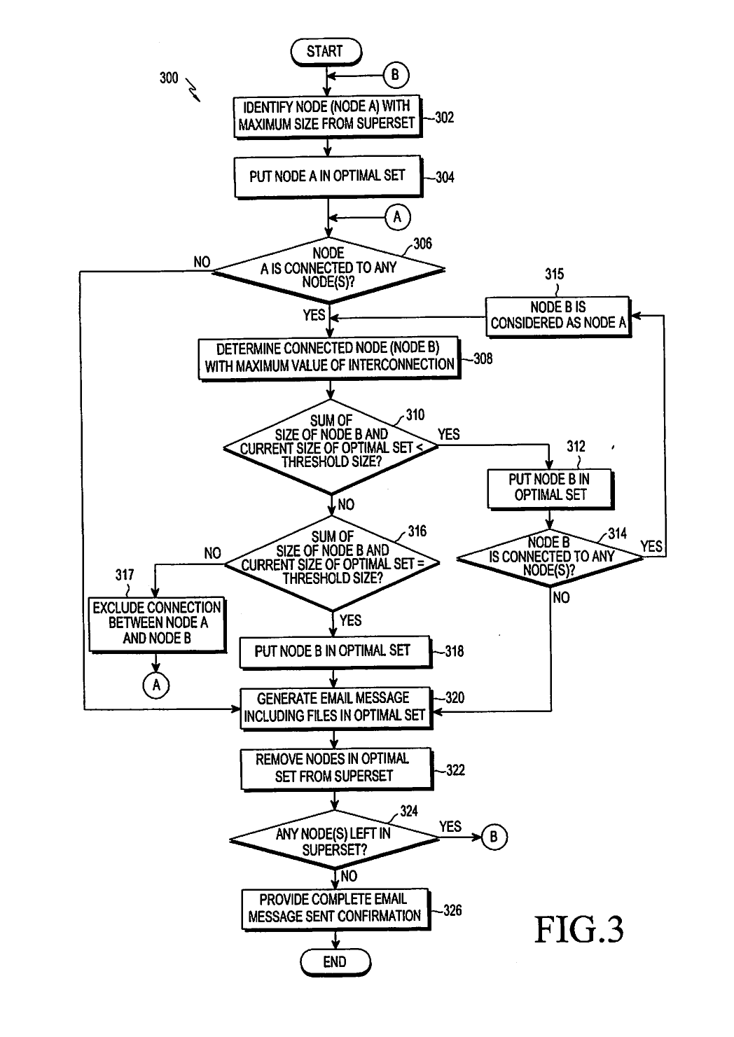

In step 206, traversal through the nodes in the superset is performed. For example, the traversal is started from the first node with the largest size to another connected node having a largest value of interconnection between the two nodes. In step 208, an optimal set of attachment files is determined based on the traversal through the nodes in the superset. Steps 206 and 208 are described in greater detail below, with respect to FIG. 3.

FIG. 3 is a flowchart illustrating the forming of one or more optimal sets from the superset of attachment files, according to an embodiment of the present invention.

In step 302, a node, associated with an attachment file, having a largest size is identified from the superset. In step 304, the identified node (hereinafter referred as node A) is put in an optimal set of attachment files. In step 306, it is determined whether node A is connected to any nodes in the superset of attachment files. If node A is connected, a node (hereinafter referred to as node B) connected with the node A that results in a largest value of interconnection is determined in step 308. If node A is not connected, the methodology proceeds to step 320.

In step 310, it is determined whether a sum of the sizes of the attachment file associated with node B and the attachment file(s) associated with the node(s) (e.g., the node A) in the optimal set is less than or equal to the threshold size. If the sum is less than the threshold size, node B is put in the optimal set of attachment files, in step 312. In step 314, it is determined whether node B is connected to any other nodes in the superset of attachment files. If node B is connected, node B is redefined as node A in step 315 and the methodology returns to step 308. If node B is not connected, the methodology proceeds to step 320.

If, in step 310, it is determined that the sum is greater than the threshold size, it is determined whether the sum of sizes of the attachment file associated with node B and the attachment file(s) associated with the node(s) (e.g., the node A) in the optimal set is equal to the threshold size. If the sum is not equal to the threshold size, the interconnection between node A and node B is excluded in step 317, and the methodology returns to step 306. If the sum is equal to the threshold size, node B is put in the optimal set of attachment files, in step 318.

In step 320, an email message including attachment files associated with the nodes (e.g., the node A and the node B) in the optimal set is generated and sent to a recipient. In 322, the nodes in the optimal set (e.g., node A and the node B) are removed from the superset of attachment files. In step 324, it is determined whether there are any nodes left in the superset. If any node remain in the superset, the methodology returns to step 302, and steps 302-324 are repeated until all the nodes corresponding to the attachment files in the superset are included in one or a plurality of optimal sets. If, in step 324, it is determined that there are no nodes remaining in the superset, a confirmation regarding the sending of the complete email message along with the attachment files is provided to the user.

Therefore, through the foregoing steps of FIG. 3, the attachment files are not split individually but are delivered intact to the recipient user through one or more email messages.

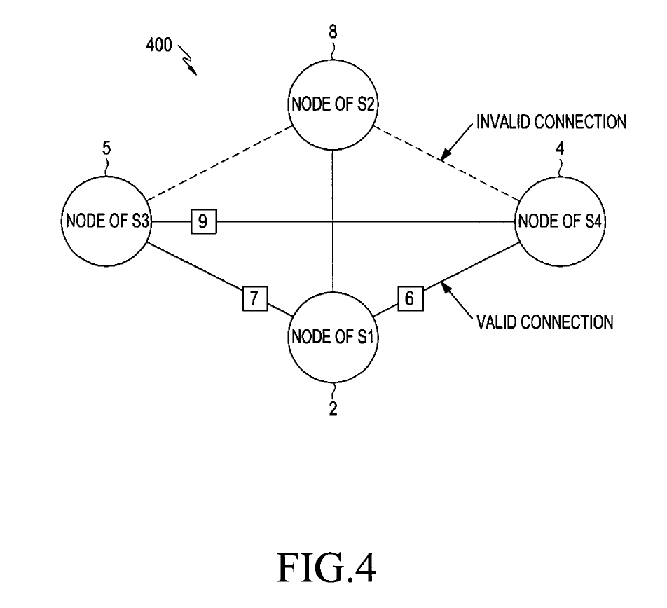

FIG. 4 is a schematic representation 400 illustrating construction of a superset and forming of optimal sets using the superset, according to an embodiment of the present invention.

In an embodiment of the present invention, it is assumed that the user wishes to send four attachment files S1, S2, S3 and S4 of sizes 2 MB, 8 MB, 5 MB and 4 MB, respectively. The total permissible size limit per email message is 10 MB.

According to an embodiment of the present invention, the attachment files are sorted in decreasing size order, i.e., S2, S3, S4 and S1. Then, a superset of the attachment files S2, S3, S4 and S1 is constructed. As shown in FIG. 4, four nodes 8, 5, 4, and 2 corresponding to the attachment files S2, S3, S4 and S1 are created.

Each node carries a value equal to the size of one of the attachment files. Further, valid interconnections are created between the nodes. For example, it is determined whether a sum of sizes of attachment files represented by node 8 and node 5 is greater than 10. Since, the sum is 13 MB, which is greater than the maximum permissible size, node 8 and node 5 cannot be connected. Similarly, it is determined whether the sum of sizes of attachment files represented by node 8 and node 4 is greater than 10. Since the sum is 12 MB, node 8 and node 4 are not connected.

As shown in FIG. 4, nodes 8 and 2, nodes 5 and 4, nodes 5 and 2, and nodes 4 and 2 are connected, as the sum of sizes of respective attachment files is less than or equal to 10 MB. The connection between any two nodes in a superset is invalid if the sum of sizes of respective attachment files is greater than the maximum permissible size (also referred to as the preset threshold size). The interconnection between nodes 8 and 2 is assigned an interconnection value 10 as the sum of the sizes of the respective attachment files is 10 MB. Similarly, nodes 5 and 4, nodes 5 and 2 and nodes 4 and 2 are assigned interconnection values 9, 7 and 6, respectively.

During optimal set formation, traversal of the superset is started from node 8, which has largest size of the attachment files. Since the interconnection value between node 8 and node 2 has a value of 10, the first optimal set includes the attachment files of size 8 MB and 2 MB. Therefore, a first email message sent to a recipient includes the attachment files S2 and 51.

Thereafter, node 8 and node 2, which are the attachment files of the first email, are removed from the superset of FIG. 4. The remaining nodes in the superset are node 5 and node 4. The connection between node 5 and node 4 has an interconnection value of 9, which is a greatest value in the superset. Thus, the second optimal set includes the attachment files of sizes 5 MB and 4 MB. The second email message sent to recipient user includes the attachment files S3 and S4, and node 5 and node 4, which are the attachment files of the second email, are removed from the superset of FIG. 4, after which no nodes remain in the superset.

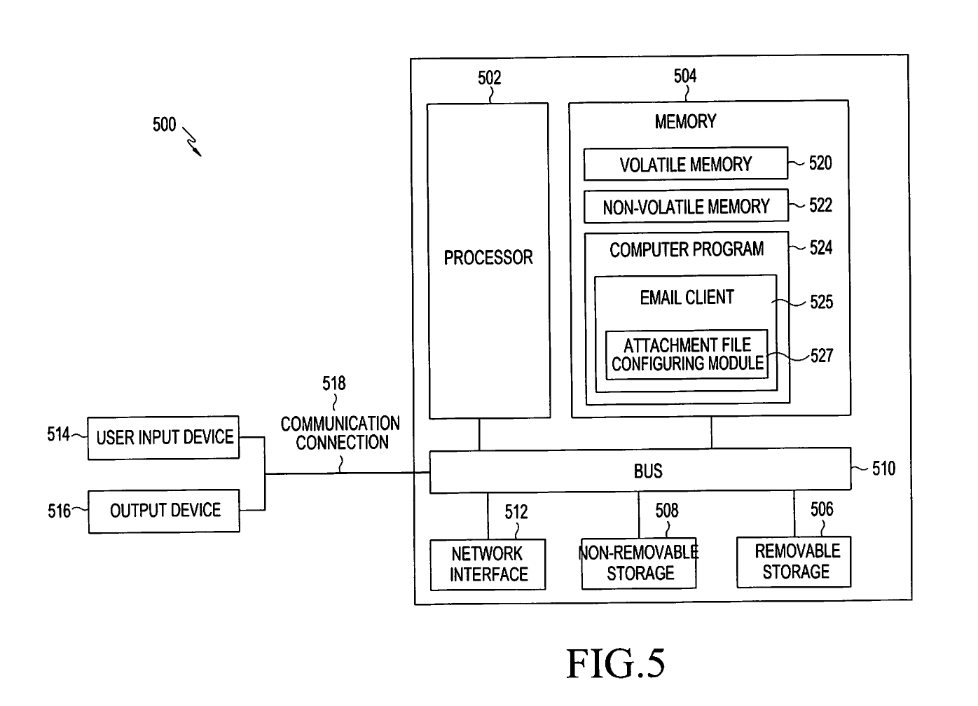

FIG. 5 is a structural diagram of a computing device, according to an embodiment of the present invention.

FIG. 5 and the following discussion are intended to provide a brief, general description of a suitable computing device 500 in which embodiments of the present invention may be implemented.

The computing device 500, such as, for example, a desktop, a laptop, a PDA, a smart phone, a mobile phone, may include a processor 502, a memory 504, a removable storage 506, and a non-removable storage 508. The computing device 500 additionally includes a bus 510 and a network interface 512. The computing device 500 may include or have access to a computing environment that includes one or more user input devices 514, one or more output devices 516, and one or more communication connections 518, such as, for example, a network interface card or a Universal Serial Bus (USB) connection. The one or more user input devices 514 may be embodied as, for example, a keyboard, a mouse, and the like. The one or more output devices 516 may be embodied as a display, a printer, a scanner and the like. The communication connections 518 may include, for example, a Local Area Network (LAN), a Wide Area Network (WAN), and the like.

The memory 504 may include a volatile memory 520 and a non-volatile memory 522. A variety of computer-readable storage media may be stored in and accessed from the memory elements of the computing device 500, such as the volatile memory 520 and the non-volatile memory 522, the removable storage 506 and the non-removable storage 508. Computer memory elements may include any suitable memory device for storing data and machine-readable instructions, such as, for example, Read Only Memory (ROM), Random Access Memory (RAM), Erasable Programmable ROM (EPROM), Electrically Erasable Programmable ROM (EEPROM), a hard drive, a removable media drive for handling Compact Disks (CDs), Digital Video Disks (DVDs), diskettes, magnetic tape cartridges, memory cards, Memory Sticks™, and the like.

The processor 502, as used herein, refers to any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, and the like.

Embodiments of the present invention may be implemented in conjunction with program modules, including functions, procedures, data structures, and application programs, for performing tasks, or defining abstract data types or low-level hardware contexts.

Machine-readable instructions stored on any of the above-mentioned storage media may be executable by the processor 502 of the computing device 500. For example, a computer program 524 may include an email client 525, and the email client 525 has an attachment file configuring module 527 in the form of machine-readable instructions capable of configuring an email communication based on attachment files, according to the teachings and herein described with respect to embodiments of the present invention.

For example, the attachment file configuring module 527 receives a selection of a plurality of attachment files associated with an email communication from a user of the email client 525, and determines at least one parameter associated with the plurality of attachment files selected by the user. The attachment file configuring module 527 determines whether the at least one parameter associated with the plurality of attachment files is greater than a threshold value. The attachment file configuring module 527 generates a plurality of email messages associated with the email communication including the plurality of attachment files based on the determination, where the plurality of email messages are generated based on optimal sets of attachment files. Moreover, the attachment file configuring module 527 sends one or more email messages to a recipient user.

According to an embodiment of the present invention, the computer program 524 may be included on a CD-ROM and loaded from the CD-ROM to a hard drive in the non-volatile memory 522. The machine-readable instructions may cause the computing device 500 to encode according to the various embodiments of the present subject matter.

By providing a method and device for automatically configuring an email communication based on attachment files, an attachment file can be conveniently sent through an email message without reconfiguring the email message due to the size of the attachment file.

Although the present invention has been shown and described with reference to certain embodiments thereof, it will be understood by those skilled in the art that various changes in form and detail may be made therein without departing from the spirit and scope of the invention as defined by the appended claims. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method for automatically configuring an email communication, the method comprising the steps of:
when a plurality of files are selected for attachment to an email message, determining at least one parameter associated with the plurality of files; and
when the at least one parameter is greater than a threshold, generating a plurality of email messages comprising the plurality of files based on an optimal set of files from the plurality of files, wherein the optimal set is determined according to individual sizes of each of the plurality of files; and
sending the plurality of email messages.

2. The method of claim 1, wherein the at least one parameter comprises a number of the plurality of files, a total size of the plurality of files, and a size of each of the plurality of files.

3. The method of claim 1, wherein generating the plurality of email messages comprises:
comparing a size of each of the plurality of files with the threshold;
when the size of each of the plurality of files is less than or equal to the threshold, comparing a total size of the plurality of files with the threshold; and
when the total size of the plurality of files is greater than the threshold, determining the optimal set of files.

4. The method of claim 3, further comprising, when a file has a size that is greater than the threshold, providing an error notification indicating that the file is of a large size.

5. The method of claim 3, further comprising, when the total size of the plurality of files is less than or equal to the threshold, generating an email message comprising the plurality of files.

6. The method of claim 3, wherein determining the optimal set comprises:
sorting the plurality of files in an order of decreasing size;
constructing a superset of the plurality of files;
creating a node for each of the plurality of files of the superset;
comparing a sum of sizes of files corresponding to any two of the nodes with the threshold;
when the sum of the sizes of the files corresponding to any two of the nodes is less than or equal to the threshold, forming a connection between the two nodes and assigning an interconnection value to the two nodes; and
determining the optimal set from the superset by comparing interconnection values of the connected files.

7. The method of claim 6, wherein the interconnection value is equal to the sum of the sizes of the files corresponding to the two connected nodes.

8. The method of claim 6, wherein determining the optimal set comprises:
selecting a first node of a file having a largest size, from among the plurality of files of the superset, for the optimal set;
determining whether there is a node connected with the first node;
when a second node is connected with the first node, comparing a sum of a size of a file corresponding to the second node and a size of the optimal set with the threshold; and
when the sum is less than or equal to the threshold, selecting the second node for the optimal set.

9. The method of claim 8, further comprising:
when the sum of the size of the file corresponding to the second node and the size of the optimal set is greater than the threshold, determining whether the sum of the size of the file corresponding to the second node and the size of the optimal set is equal to the threshold; and
if the sum of the size of the file corresponding to the second node and the size of the optimal set is equal to the threshold, selecting the second node for the optimal set.

10. The method of claim 9, further comprising, when the sum of the size of the file corresponding to the second node and the size of the optimal set is not equal to the threshold, excluding the connection between the first node and the second node.

11. The method of claim 8, further comprising removing one or more nodes selected for the optimal set from the superset.

12. An apparatus for automatically configuring an email communication, the device comprising:
an email client for determining at least one parameter associated with a plurality of files to be included in an email message, and, when the at least one parameter is greater than a threshold, generating a plurality of email messages comprising the plurality of files based on an optimal set of files from the plurality of files, wherein the optimal set is determined according to individual sizes of each of the plurality of files, and sending the plurality of email messages.

13. The apparatus of claim 12, wherein the at least one parameter comprises a number of the plurality of files, a total size of the plurality of files, and a size of each of the plurality of files.

14. The apparatus of claim 12, wherein, when the size of each of the plurality of files is less than or equal to the threshold, the email client compares a total size of the plurality of files with the threshold, and, when the total size of the plurality of files is greater than the threshold, the email client determines the optimal set of files to generate the plurality of email messages.

15. The apparatus of claim 14, wherein, when the total size of the plurality of files is less than or equal to the threshold, the email client generates an email message comprising the plurality of files.

16. The apparatus of claim 14, wherein the email client sorts the plurality of files in an order of decreasing size, constructs a superset of the plurality of files, creates a node for each of the plurality of files of the superset, compares a sum of sizes of files corresponding to any two of the nodes with the threshold; when the sum of the sizes of the files corresponding to any two of the nodes is less than or equal to the threshold, forms a connection between the two nodes and assigning an interconnection value to the two nodes, and determines the optimal set from the superset by comparing interconnection values of the connected files.

17. The apparatus of claim 16, wherein the email client selects a first node of a file having a largest size, from among the plurality of files of the superset, for the optimal set, determines whether there is a node connected with the first node, when a second node is connected with the first node, compares a sum of a size of a file corresponding to the second node and a size of the optimal set with the threshold, and when the sum is less than or equal to the threshold, selects the second node for the optimal set.

18. The apparatus of claim 17, wherein, when the sum of the size of the file corresponding to the second node and the size of the optimal set is greater than the threshold, the email client determines whether the sum of the size of the file corresponding to the second node and the size of the optimal set is equal to the threshold, and, when the sum of the size of the file corresponding to the second node and the size of the optimal set is equal to the threshold, the email client selects the second node for the optimal set.

19. The apparatus of claim 18, wherein, when the sum of the size of the file corresponding to the second node and the size of the optimal set is not equal to the threshold, then the email client excludes the connection between the first node and the second node.

20. The apparatus of claim 17, wherein the email client removes one or more nodes selected for the optimal set from the superset.
